(19) United States
(12) Patent Application Publication
(10) Pub. No.: US 2018/0203637 A1
(43) Pub. Date: Jul. 19, 2018

(54) STORAGE CONTROL APPARATUS AND STORAGE CONTROL PROGRAM MEDIUM

(71) Applicant: FUJITSU LIMITED, Kawasaki-shi (JP)

(72) Inventor: MASANORI FURUYA, Kawasaki (JP)

(73) Assignee: FUJITSU LIMITED, Kawasaki-shi (JP)

(21) Appl. No.: 15/866,517

(22) Filed: Jan. 10, 2018

(30) Foreign Application Priority Data
Jan. 16, 2017 (JP) 2017-004820

(51) Int. Cl. G06F 3/06; G06F 13/14; G06F 12/02

(52) U.S. Cl. CPC G06F 3/0641; G06F 3/0652; G06F 13/14; G06F 12/0246; G06F 3/0689; G06F 3/0608; G06F 3/061; G06F 3/0688; G06F 3/0659

(57) ABSTRACT

A storage control program, for a system having a storage including divided regions including non-duplicate data that do not overlap with one another, causing a computer to perform a process including; storing logical address information including, for each of logical addresses, identification information of the divided regions allocated to the logical addresses and reservation information indicating whether or not there is a reservation for deletion of data in the divided region, updating, in response to a deletion request, the reservation information corresponding to the range of the logical addresses of the deletion target data in the logical address information to presence of a reservation for deletion, performing deletion processing for transmitting response information regarding the deletion request to a request source of the deletion request, and performing, separately from the deletion processing, updating the reference information regarding the logical address.

### CROSS-REFERENCE TO RELATED APPLICATION

This application is based upon and claims the benefit of priority of the prior Japanese Patent Application No. 2017-4820, filed on Jan. 16, 2017, the entire contents of which are incorporated herein by reference.

### FIELD

The embodiments discussed herein are related to a storage control apparatus and a storage control program medium.

### BACKGROUND

A deduplication technique for detecting identical data items from among a plurality of data items in a storage, reserving one of the identical data items, deleting the other data items, and managing the number of logical addresses for reference to the reserved data item in accordance with a physical address of the reserved data item has been available.

For example, a technique for storing part of records of a table representing data association including chunk groups and chunk data belonging to the chunk groups into a memory and carrying out reflection in the table asynchronously in response to a deletion request has been available as a related art. For example, see International Publication Pamphlet No. WO 2015/198371. Furthermore, a technique for storing a first data sequence that is subjected to deduplication into a first memory region formed by a plurality of memory devices and storing a second data sequence generated based on an original data sequence for which deduplication has not been performed on the first data sequence into a continuous region of a second memory region having the same performance characteristics as those of the first memory region has also been available. See for example, International Publication Pamphlet No. WO 2014/136183.

However, in the related arts, when a deletion request is issued to a storage to which a deduplication technique is applied, there may be a delay in response to the deletion request. Specifically, a larger amount of deletion target data is composed of a larger number of blocks. Therefore, the number of times a corresponding physical address is identified from a logical address, which is performed for each block, and the number of update parts for the number of logical addresses for reference to reserved data increase, and a response to the deletion request is thus delayed. Due to the delay in the response to the deletion request, a response may not be given to a request source of the deletion request within a timeout period for the deletion request.

An object of the embodiments is to provide a storage control apparatus and a storage control program that are capable of shortening the time spent to respond to a deletion request in a storage to which a deduplication technique is applied.

### SUMMARY

According to an aspect of the invention, a storage control program, for a system having a storage including divided regions including non-duplicate data that do not overlap with one another, causing a computer to perform a process including; storing logical address information including, for each of logical addresses, identification information of the divided regions allocated to the logical addresses and reservation information indicating whether or not there is a reservation for deletion of data in the divided region, updating, in response to a deletion request, the reservation information corresponding to the range of the logical addresses of the deletion target data in the logical address information to presence of a reservation for deletion, performing deletion processing for transmitting response information regarding the deletion request to a request source of the deletion request, and performing, separately from the deletion processing, updating the reference information regarding the logical address.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an operation example of a storage control apparatus according to an embodiment;

FIG. 2 is an explanatory diagram illustrating an example of a configuration of a storage system;

FIG. 3 is an explanatory diagram illustrating an example of an operation performed when an UNMAP command for Thin Provisioning is received;

FIG. 4 is an explanatory diagram illustrating an example of a functional configuration of a CM according to a first embodiment;

FIG. 5 is an explanatory diagram illustrating an example of an operation performed when an UNMAP command is received in the first embodiment;

FIG. 6 is an explanatory diagram illustrating an example of a functional configuration of a CM according to a second embodiment;

FIG. 7 is an explanatory diagram illustrating an example of an operation performed when an UNMAP command is received in the second embodiment;

FIG. 8 is a flowchart illustrating an example of a processing procedure performed when an UNMAP command is performed in the second embodiment;

FIG. 9 is a flowchart illustrating an example of a processing procedure performed when a Write I/O command is received in the second embodiment;

FIG. 10 is an explanatory diagram illustrating an example of writing data for a case where a Write I/O range and a management unit of an UNMAP reservation flag do not match;

FIG. 11 is a flowchart illustrating an example of a processing procedure performed when a Read I/O command is received in the second embodiment; and

FIG. 12 is a flowchart illustrating an example of an asynchronous processing procedure in the second embodiment.

### DESCRIPTION OF EMBODIMENTS

Storage control apparatuses and storage control programs according to embodiments will be described in detail with reference to drawings.

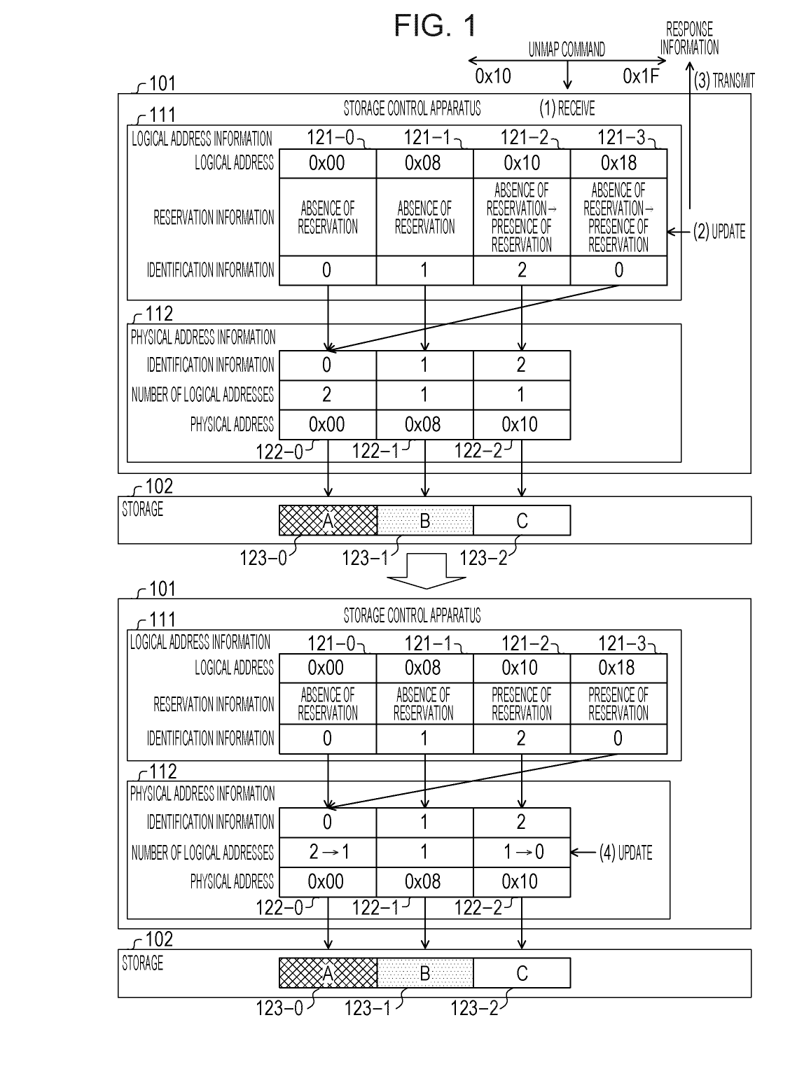

FIG. 1 is an explanatory diagram illustrating an operation example of a storage control apparatus 101 according to an embodiment. The storage control apparatus 101 is a computer that controls a storage. Specifically, the storage control apparatus 101 provides a memory region of a storage to a user. More specifically, the storage control apparatus 101 provides a volume to which a deduplication technique is applied to a host apparatus that is used by a user. The host apparatus is, for example, a server such as a virtual machine server that causes a virtual machine (VM) to operate or a moving image distribution server that distributes moving images.

In a deduplication technique, identical data items are detected from among a plurality of data items in a storage, one of the identical data items is reserved, the other data items are deleted, and the number of logical addresses for reference to the reserved data item is managed in accordance with a physical address of the reserved data item. Furthermore, in the deduplication technique, the reserved data item may be compressed. Even if reserved data items having the same size are compressed, the compressed data items may have different sizes, and the entry size of physical data is made variable. A volume to which deduplication is applied will be referred to as a “deduplication volume”.

Furthermore, the storage control apparatus 101 may adopt Thin Provisioning. Thin Provisioning is a function to reduce consumption of a physical capacity to an actual writing amount by not allocating a physical data region when a virtual volume is created but allocating a physical data storage region only to a position to which writing is performed by a host apparatus. With Thin Provisioning, in order to implement this function, an address conversion table is provided, and access may be made even when a physical address indicating an actual physical arrangement is different from a logical address. Furthermore, for Thin Provisioning, a data deletion command, which is a command for releasing an allocated physical data storage region, exists. The released physical data storage region may be reused as an empty physical capacity to which allocation is to be performed for a new write request.

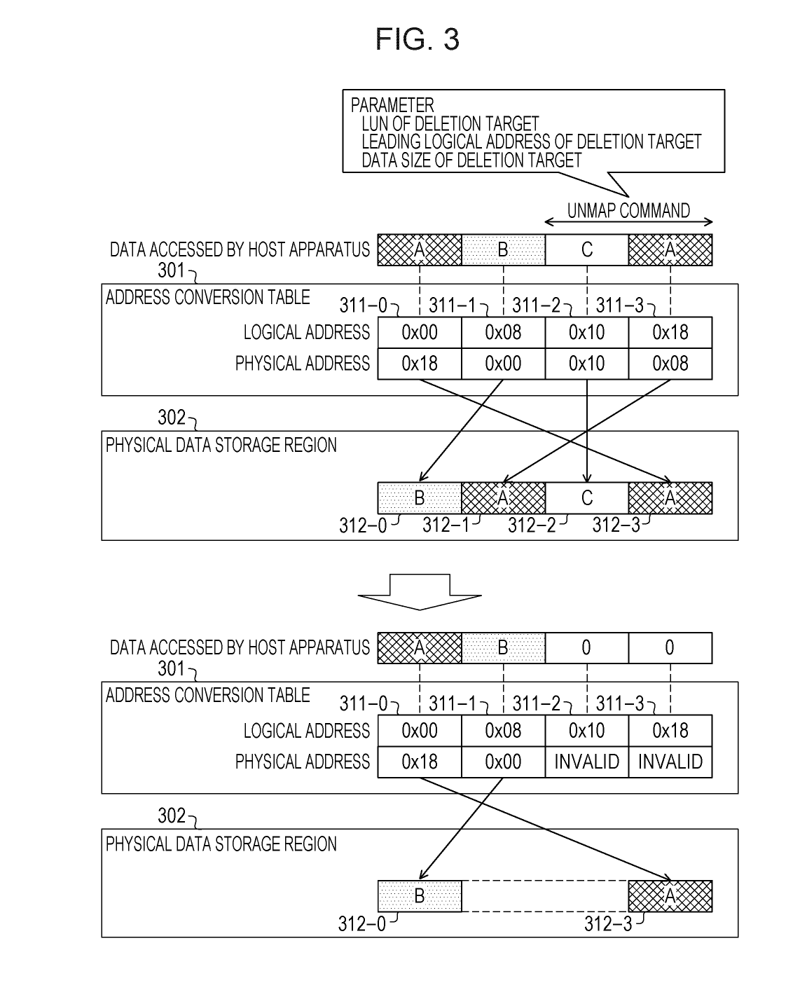

Hereinafter, a deletion request will be referred to as an “UNMAP command”. Furthermore, a write request will be referred to as a “Write I/O command”. In a similar manner, a read request will be referred to as a “Read I/O command”. An example of an address conversion table and an example of an UNMAP command are illustrated in FIG. 3.

Deletion target data based on an UNMAP command may have a size on the order of several gigabytes, and is larger than target data for a normal Read I/O command or Write I/O command. For example, in the case where a host apparatus is a virtual machine server or a moving image distribution server, an UNMAP command of a large amount of file such as data of a VM itself or a moving image file may be issued.

However, when an UNMAP command is issued to a deduplication volume, there may be a delay in response to the UNMAP command. Specifically, as the amount of deletion target data increases, the number of times that a corresponding physical address is identified based on a logical address and the number of update points of the number of logical addresses for reference to reserved data increase. Therefore, a response to an UNMAP command will be delayed. The delay in response to the UNMAP command may cause a situation in which the response is not sent to a host apparatus within a timeout period of the UNMAP command.

Furthermore, by storing management information for managing a logical address and a physical address into a high-speed random access memory, the time spent to respond to an UNMAP command may be shortened. However, a deduplication volume manages data in small units such as about 4 kilobytes. Therefore, all the pieces of management information may not be arranged in a memory, and part of the management information is arranged in a disk. In the case where the amount of deletion target data is large, when management information in a disk is accessed, it is difficult to make a response within a timeout period of an UNMAP command.

Furthermore, in a deduplication volume, a plurality of logical addresses may correspond to identical data. Therefore, the deduplication volume may store two tables: a first table in which a logical address and identification information of a region where data is stored are managed in association with the logical address; and a second table in which identification information of a region where data is stored, reference information regarding a logical address for reference to the corresponding data, and a physical address of the corresponding region are managed. An UNMAP command is specified by a logical address. Reference information regarding a logical address may be the number of logical addresses for reference to corresponding data or the logical address itself for reference to the corresponding data. Hereinafter, reference information regarding a logical address represents the number of logical addresses for reference to corresponding data.

When a corresponding region is identified based on a logical address specified by an UNMAP command and the number of logical addresses for reference to data in the identified region is updated, even if the logical addresses are continuous, the identified regions may not be continuous. Accordingly, in processing for updating the number of logical addresses for reference to the data in the identified region, random access to the second table mentioned above occurs. In the case where the second table is stored in a disk such as a hard disk drive (HDD), which is not suitable for random access, a longer time is spent to make a response to an UNMAP command.

Specifically, in the case where a file of 26.25 gigabytes is to be deleted, the number of update points of the number of logical addresses is 6.56 million (=26.25 gigabytes/4 kilobytes). In the case where the random Write I/O performance of a disk is 1,000 input output per second (IOPS), it takes 6,717 seconds (=6.56 million/1000). The timeout period from a host apparatus is, in general, about 30 seconds. Therefore, due to timeout, an error response of an UNMAP command is transmitted. Furthermore, processing based on an UNMAP command is not completed, and part of a physical data storage region to be released may not be released.

Thus, in this embodiment, a flag for deletion reservation is provided in a table that manages a logical address. By transmitting a response to an issuance source of an UNMAP command when a flag for the logical address of the UNMAP command is set to ON, the time from reception of the command until response to the command may be shortened.

An operation example of the storage control apparatus 101 will be explained below with reference to FIG. 1. The storage control apparatus 101 controls a storage 102. The storage control apparatus 101 is able to access logical address information 111 and physical address information 112.

The logical address information 111 includes, in association with each of a plurality of logical addresses, identification information for identifying a divided region allocated to the logical address among a plurality of divided regions obtained by dividing a memory region of the storage 102, and reservation information. Data included in individual divided regions are deduplicated data and do not overlap with one another. Furthermore, each of the divided regions may be obtained by equal division or unequal division. Furthermore, some logical addresses managed by the logical address information 111 may not be allocated divided regions. Identification information indicating that no divided region is allocated is set for a logical address that is not allocated a divided region. Hereinafter, such identification information will be referred to as “INVALID”. Furthermore, in the case where a Read I/O command occurs in a logical address that is not allocated a divided region, the storage control apparatus 101 sets data to be read to a predetermined value that is set when no divided region is allocated to a logical address.

Furthermore, the physical address information 112 includes, in association with each of a plurality of divided regions, the number of logical addresses for reference to the divided region and a physical address of the divided region. Reservation information indicates presence or absence of a reservation for deletion of data in any of the divided regions. In the example of FIG. 1, reservation information represents “presence of reservation” which indicates that there is a reservation or “absence of reservation” which indicates that there is no reservation.

For example, in the example of FIG. 1, the logical address information 111 includes entries 121-0 to 121-3. Furthermore, the physical address information 112 includes entries 122-0 to 122-2. Divided regions 123-0 to 123-2 obtained by dividing a memory region of the storage 102 include non-duplicate data A to C, which do not overlap with one another. Hereinafter, in the case where elements of the same type are distinguished from one another, reference signs such as “entry 121-0” and “entry 121-1” may be used. In the case where elements of the same type are not distinguished from one another, only a common number of a reference sign, such as “entry 121” may be used.

Identification information of a divided region 123 may be any type of information as long as a divided region may be identified. Identification information may be, for example, a character string including a combination of a character and a numerical value. In the example of FIG. 1, for a simplified explanation, a number excluding a common number of the divided region 123 is used as identification information for identifying the divided region 123. For example, identification information for identifying the divided region 123-0 is “0”.

For example, the entry 121-0 is an entry regarding a logical address 0x00, and indicates that the divided region 123-0 is allocated to the logical address 0x00 and there is no reservation for deletion of data in the divided region 123-0. Furthermore, the entry 122-0 is an entry regarding the divided region 123-0, and indicates that the number of logical addresses for reference to the divided region 123-0 is two and a physical address of the divided region 123-0 is 0x00.

As illustrated in (1) in an upper part of FIG. 1, the storage control apparatus 101 receives an UNMAP command. The UNMAP command is issued from a host apparatus. However, an issuance source of an UNMAP command is not limited to a host apparatus. For example, for the purpose of data migration, the storage control apparatus 101 itself may issue an UNMAP command. The UNMAP command includes the range of logical addresses of deletion target data. The UNMAP command may include, as the range of logical addresses, leading and trailing addresses or a leading address and the data size from the leading address. Furthermore, the range of logical addresses of deletion target data will be referred to as an “UNMAP range”. In the example of FIG. 1, the range of logical addresses of deletion target data is from 0x10 to 0x1F and includes logical addresses regarding the entries 121-2 and 121-3.

Next, as illustrated in (2) in an upper part of FIG. 1, the storage control apparatus 101 updates, in response to reception of the UNMAP command, reservation information corresponding to the logical addresses of the deletion target data in the logical address information 111 to presence of a reservation for deletion. In the example of FIG. 1, entries of the logical address information 111 corresponding to logical addresses of the deletion target data are entries 121-2 and 121-3. Therefore, the storage control apparatus 101 updates reservation information of the entries 121-2 and 121-3 to presence of a reservation.

Then, in response to the update of the reservation information of the logical address information 111, as illustrated in (3) in an upper part of FIG. 1, the storage control apparatus 101 performs deletion processing for transmitting response information to a request source of the deletion request, that is, the issuance source of the UNMAP command.

Furthermore, separately from the deletion processing, as illustrated in (4) in a lower part of FIG. 1, the storage control apparatus 101 performs update processing for referring to the logical address information 111 and updating reference information regarding the logical addresses in the physical address information 112. As an example of performing update processing separately from the deletion processing, the storage control apparatus 101 may perform the deletion processing and the update processing concurrently or perform the update processing asynchronously with the deletion processing. Synchronization represents a method in which processing does not start until execution of certain processing is completed. In contrast, asynchronization represents a method in which processing is performed regardless of whether or not execution of certain processing is completed. For example, the storage control apparatus 101 may perform the update processing described above with specific time intervals. Alternatively, the storage control apparatus 101 may perform the update processing described above when the number of received UNMAP commands has reached a predetermined value or more or after a specific time has passed since the size of the total range of logical addresses specified by UNMAP commands has reached a predetermined value or more.

In the example of FIG. 1, reservation information of the entries 121-2 and 121-3 represents “presence of reservation”. Therefore, the storage control apparatus 101 decrements the number of logical addresses of the entries 122-2 and 122-0 corresponding to the entries 121-2 and 121-3, respectively. Although not illustrated in FIG. 1, after decrementing the number of logical addresses of the entries 122-0 and 122-2, the storage control apparatus 101 releases the divided region 123-2, and sets identification information of the entries 121-2 and 121-3 to “INVALID”.

As described above, the storage control apparatus 101 is able to respond to an UNMAP command only by updating reservation information of the logical address information 111. Therefore, the time spent to make a response may be shortened. More specifically, the storage control apparatus 101 is able to respond to an UNMAP command without identifying a divided region based on a logical address or without randomly accessing the physical address information 112. In this case, update in the logical address information 111 occurs. The update in the logical address information 111 is sequential access, and therefore, even if update is performed many times, it takes a shorter time than update in the physical address information 112.

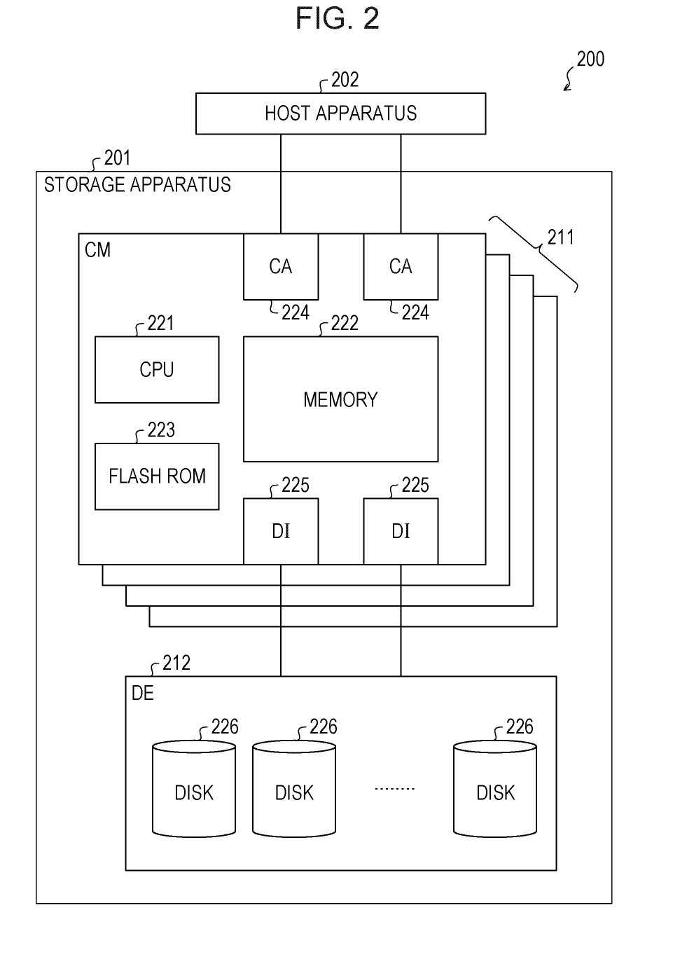

This embodiment may also be applied to a volume to which a redundant arrays of inexpensive disks (RAID) technique is applied. Next, a case where the storage control apparatus 101 is applied to a storage system 200 will be described below with reference to FIG. 2.

FIG. 2 is an explanatory diagram illustrating an example of a configuration of the storage system 200. The storage system 200 illustrated in FIG. 2 includes a storage apparatus 201 and a host apparatus 202. The storage apparatus 201 includes one or more controller modules (CMs) 211 and a drive enclosure (DE) 212. The CMs 211 each include a central processing unit (CPU) 221, a memory 222, a flash read only memory (ROM) 223, a channel adapter (CA) 224, and a disk interface (DI) 225. The DE 212 includes one or more disks 226.

Each of the CMs 211 corresponds to the storage control apparatus 101 illustrated in FIG. 1. Each of the disks 226 corresponds to the storage 102 illustrated in FIG. 1.

The storage apparatus 201 provides a memory region of the disk 226 to another computer. The host apparatus 202 is a computer connected to the storage apparatus 201. The host apparatus 202 uses a memory region provided by the storage apparatus 201. For example, the host apparatus 202 is a Web server.

Each of the CMs 211 is a device that controls the storage apparatus 201. The DE 212 is a housing that includes the disks 226. The CPU 221 is a device that manages the entire control of the CMs 211. The CPU 221 may include a plurality of cores. The memory 222 is a volatile memory that operates as a cache memory inside the CPU 221. For example, a dynamic random access memory (DRAM) is adopted as the memory 222.

The flash ROM 223 is a nonvolatile memory that stores a storage control program according to this embodiment. For example, a NOR flash memory or a NAND flash memory may be adopted as the flash ROM 223.

The CA 224 is a device that manages interface with the host apparatus 202. The DI 225 is a device that manages interface with the disk 226.

Next, regarding an example of an operation performed when an UNMAP command for Thin Provisioning is received, an example of an operation for a volume to which deduplication is not applied will be described below.

FIG. 3 is an explanatory diagram illustrating an example of an operation performed when an UNMAP command for Thin Provisioning is received. With reference to FIG. 3, a case where an UNMAP command is received in a Thin Provisioning Volume will be described. In FIG. 3, an address conversion table 301 in which a logical address is associated with a physical address and a physical data storage region 302 that stores physical data are illustrated. The address conversion table 301 illustrated in FIG. 3 includes entries 311-0 to 311-3. As illustrated in an upper part of FIG. 3, the entry 311-0 stores a correspondence between a logical address 0x00 and a physical address 0x18. In a similar manner, the entries 311-1 to 311-3 store a correspondence between a logical address 0x08 and a physical address 0x00, a correspondence between a logical address 0x10 and a physical address 0x10, and a correspondence between a logical address 0x18 and a physical address 0x08, respectively.

The physical data storage region 302 includes divided regions 312-0 to 312-3. The divided regions 312-0 to 312-3 include data B, A, C, and A, respectively. The logical addresses 0x00, 0x08, 0x10, and 0x18 are allocated the divided regions 312-3, 312-0, 312-2, and 312-1, respectively.

An UNMAP command includes, as parameters, a logical unit number (LUN) of a deletion target, a leading logical address of the deletion target, and the data size of the deletion target.

For example, an UNMAP command to logical addresses 0x10 to 0x1F is issued to a Thin Provisioning volume. In this case, as illustrated in a lower part of FIG. 3, a device that manages the address conversion table 301 releases the divided regions 312-2 and 312-1 that are allocated to the logical addresses 0x10 and 0x18, respectively. The released divided regions 312-2 and 312-1 may be reused.

### First Embodiment

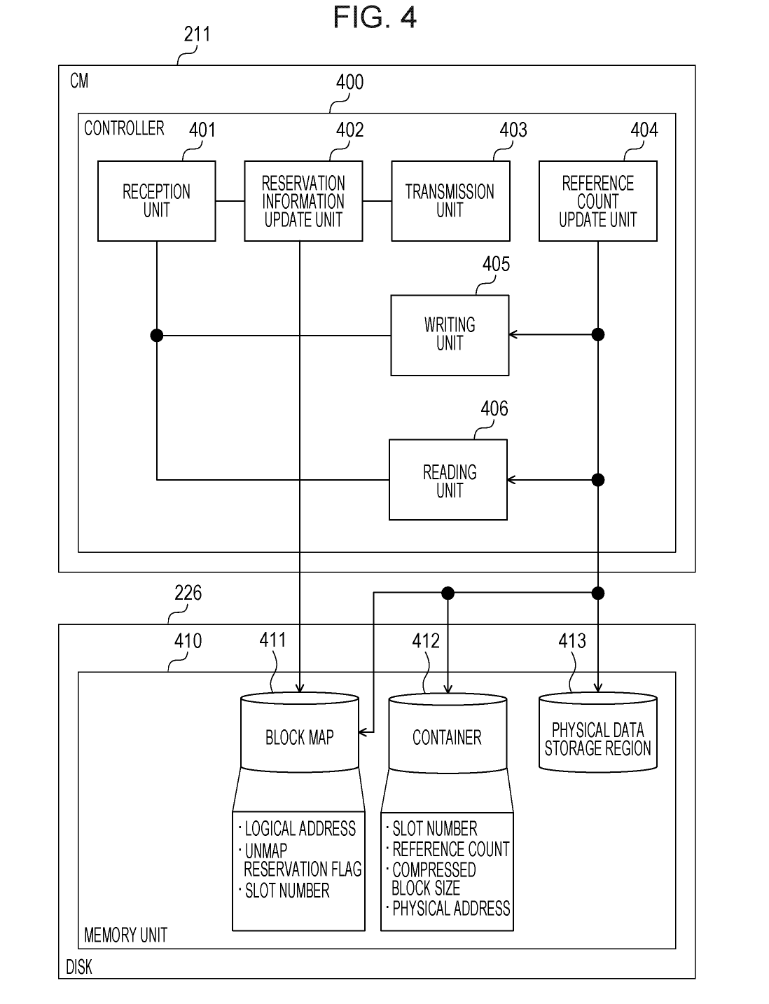

Next, an example of a functional configuration of the CM 211 according to a first embodiment in which the storage control apparatus 101 illustrated in FIG. 1 is applied to the CM 211 illustrated in FIG. 2 will be described with reference to FIG. 4.

FIG. 4 is an explanatory diagram illustrating an example of a functional configuration of the CM 211 according to the first embodiment. The CM 211 according to the first embodiment includes a controller 400. The controller 400 includes a reception unit 401, a reservation information update unit 402, a transmission unit 403, a reference count update unit 404, a writing unit 405, and a reading unit 406. The controller 400 implements functions of the individual units when the CPU 221 executes a program stored in a memory device. The memory device is, for example, the flash ROM 223 illustrated in FIG. 2 or the like. Furthermore, processing results of the individual units are stored in the memory 222, a register of the CPU 221, a cache memory of the CPU 221, or the like.

Furthermore, the CM 211 is able to access a memory unit 410. The memory unit 410 is stored in a memory device such as the disk 226. The memory unit 410 includes a block map 411, a container 412, and a physical data storage region 413. The block map 411 corresponds to the logical address information 111 illustrated in FIG. 1. The container 412 corresponds to the physical address information 112 illustrated in FIG. 1.

The block map 411 includes fields of a logical address, an UNMAP reservation flag, and a slot number. The UNMAP reservation flag corresponds to the reservation information illustrated in FIG. 1. Furthermore, in the UNMAP reservation flag field, “ON” that represents presence of a reservation or “OFF” that represents absence of a reservation is stored. “ON” and “OFF” may be any values. For example, “ON” and “OFF” may be “1” and “0”, respectively. The slot number corresponds to identification information for identifying the divided region 123 illustrated in FIG. 1. In the example of FIG. 4, the slot number is identification information for identifying a divided region obtained by dividing the physical data storage region 413.

The container 412 includes fields of a slot number, a reference count, a compressed block size, and a physical address. The reference count corresponds to the number of logical addresses illustrated in FIG. 1. In the example of FIG. 4, the reference count represents the number of logical addresses for reference to data in a divided region represented by a slot number. The compressed block size is the size of a block after compression is performed. Compressed data items have different sizes according to the details of the data item, and therefore, the size of a divided region represented by a slot number is variable.

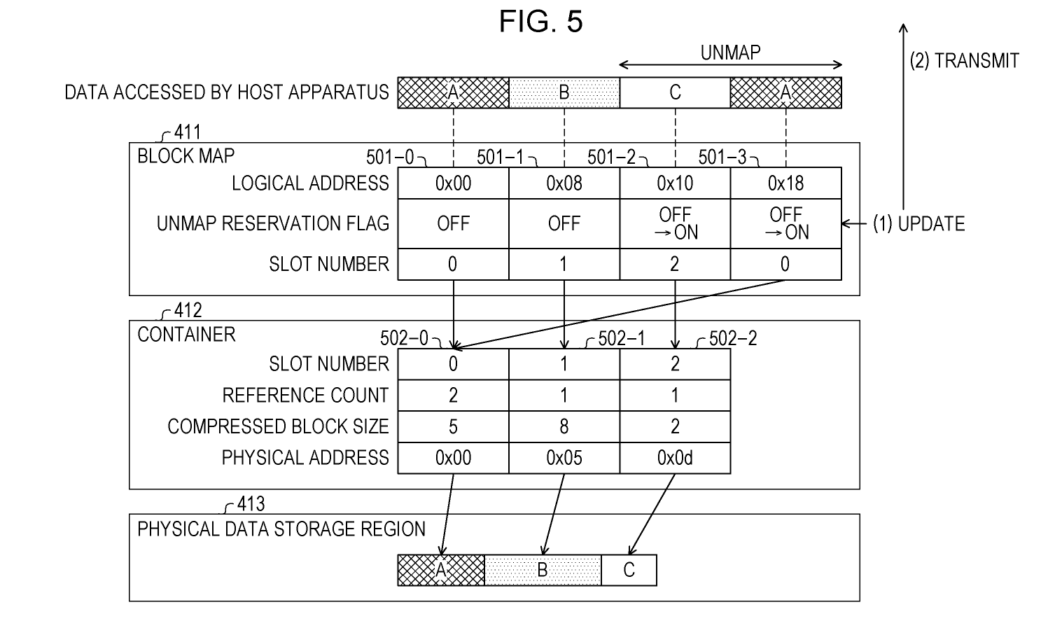

Furthermore, in the example of FIG. 4, the block map 411, the container 412, and the physical data storage region 413 are present in the same disk 226. However, the block map 411, the container 412, and the physical data storage region 413 may be present in different disks 226. Furthermore, the block map 411, the container 412, and the physical data storage region 413 may be spread over multiple disks 226. However, it is desirable that entries of the block map 411 be stored in the disk 226 so that they are arranged in continuous logical addresses. An example of stored contents of the block map 411, the container 412, and the physical data storage region 413 is illustrated in FIG. 5.

The reception unit 401 receives a command from the host apparatus 202. Specifically, the reception unit 401 receives an UNMAP command, a Write I/O command, and a Read I/O command from the host apparatus 202. The Write I/O command includes write target data and the range of logical addresses of the write target data. In a similar manner, the Read I/O data includes the range of logical addresses of read target data.

Hereinafter, for uniformity of terms, write target data will be referred to as “Write data”, the range of logical addresses of write target data will be referred to as a “Write I/O range”, and the range of logical addresses of read target data will be referred to as a “Read I/O range”. Furthermore, for a Read I/O command, data of a Read I/O range, which is included in a response, will be referred to as “Read data”.

When the reception unit 401 receives an UNMAP command, the reservation information update unit 402 updates a UNMAP reservation flag corresponding to logical addresses of deletion target data in the block map 411 to “ON”.

After the reservation information update unit 402 updates the UNMAP reservation flag in the block map 411, the transmission unit 403 performs deletion processing for transmitting response information regarding the UNMAP command to the host apparatus 202, which is an issuance source of the UNMAP command.

Separately from the deletion processing by the transmission unit 403, the reference count update unit 404 performs update processing for referring to the block map 411 and updating a reference count of the container 412. Specifically, the reference count update unit 404 decrements, as the update processing, by one the reference count of the container 412 corresponding to the slot number for which the UNMAP reservation flag in the block map 411 is set to “ON”. Furthermore, the reference count update unit 404 sets “INVALID” as an identifier indicating that no divided region is allocated to a logical address, for the slot number for which the UNMAP reservation flag in the block map 411 is set to “ON”. As a result of the updating, the reference count update unit 404 releases the divided region for which the reference count has reached 0.

When the reception unit 401 receives the Write I/O command, in the case where the UNMAP reservation flag corresponding to the Write I/O range in the block map 411 indicates “ON”, the writing unit 405 updates the UNMAP reservation flag to “OFF”. Furthermore, the writing unit 405 writes, as normal deduplication processing, data obtained by removing duplication between Write data and each data included in each divided region in the physical data storage region 413 into any of the divided regions.

When the reception unit 401 receives a Read I/O command, in the case where the UNMAP reservation flag corresponding to the Read I/O range in the block map 411 indicates “ON”, the reading unit 406 sets Read data to a predetermined value. The predetermined value is a value to be set when no divided region is allocated to a logical address. Cases where no divided region is allocated to a logical address include a state immediately after a ThinProvisioning volume is created and a state when a divided region is released based on an UNMAP command. In the case where no divided region is allocated to an address, “INVALID” is set for a corresponding slot number. Furthermore, any value may be set as the predetermined value. For example, the predetermined value is represented by data composed of only 0 or data of 0xFF. Hereinafter, the predetermined value will be referred to as “0 data”. Read data is set to 0 data so that the same result as that for Read data when a Read I/O command is issued to a logical address for which a divided region is released may be obtained.

A case where an UNMAP reservation flag corresponding to a part of a Read I/O range indicates “ON” and an UNMAP reservation flag corresponding to the other part of the Read I/O range indicates “OFF” may exist. In this case, the reading unit 406 sets data corresponding to “ON” in the Read data to 0 data, and data corresponding to “OFF” is set to data read from the disk 226 by referring to the container 412 and the like.

A Write I/O range may not match a management unit of an UNMAP reservation flag. In this case, the writing unit 405 interpolates 0 data for data within a range of the UNMAP reservation flag but outside the Write I/O range, and writes the interpolated data to the disk 226.

FIG. 5 is an explanatory diagram illustrating an example of an operation performed when an UNMAP command is received in the first embodiment. Prior to explaining an operation performed when an UNMAP command is received, an example and relationship of stored contents in the block map 411, the container 412, and the physical data storage region 413 will be explained with reference to FIG. 5. The block map 411 illustrated in FIG. 5 includes entries 501-0 to 501-3. The container 412 illustrated in FIG. 5 includes entries 502-0 to 502-2.

With reference to FIG. 5, the relationship of data managed by a logical address and data managed by a physical address will be explained. The entries 501-0 to 501-3 manage data of the logical addresses 0x00, 0x08, 0x10, and 0x18, respectively. Accordingly, a management unit of an UNMAP reservation flag illustrated in FIG. 5 is 8 bytes. The host apparatus 202 specifies the logical address 0x00 to access the data A. In a similar manner, the host apparatus 202 specifies the logical address 0x08 to access the data B, specifies the logical address 0x10 to access the data C, and specifies the logical address 0x18 to access the data A. As described above, the logical address 0x00 and the logical address 0x18 are specified so that the same contents, the data A, is accessed. In FIG. 5, the data A is represented in a thick hatching pattern, and the data B is represented in a light hatching pattern.

The same data is accessed by specifying the logical address 0x00 and the logical address 0x18. Therefore, a slot number of each of the entries 501-0 and 501-3 is “0”. Furthermore, a slot number of the entry 501-1 is “1”, and the slot number of the entry 501-2 is “2”.

The entry 502-0 having the slot number “0” manages data of the physical address 0x00. In a similar manner, the entry 502-1 having the slot number “1” manages data of the physical address 0x05, and the entry 502-2 having the slot number “2” manages data of the physical address 0x0d. Compressed data A is stored in the physical address 0x00 in the physical data storage region 413. In a similar manner, compressed data B and C are stored in the physical addresses 0x05 and 0x0d, respectively, in the physical data storage region 413.

In the case where the CM 211 receives an UNMAP command to the logical addresses 0x10 to 0x18 as an address range from the host apparatus 202, the CM 211 changes an UNMAP reservation flag of the entries 501-2 and 501-3 corresponding the address range in the block map 411 from OFF to ON, as illustrated in (1) of FIG. 5. Then, the CM 211 transmits response information regarding the UNMAP command to the host apparatus 202, as illustrated in (2) of FIG. 5. The entries 501-0 to 501-3 exist in continuous regions in the disk 226, and therefore, update of the UNMAP reservation flag based on the UNMAP command is sequential access. Thus, even if the number of UNMAP reservation flags to be updated is large, only a short time is spent compared to update of a reference count in the container 412.

Furthermore, the CM 211 performs updating of the reference count in the container 412, asynchronously with reception of the UNMAP command.

Explanation will be provided below using specific numerical values. For example, in the case where the maximum data size that may be specified by an UNMAP command is 26.25 gigabytes and 16 bytes of entries in the block map 411 are secured for every 4 kilobytes, when an UNMAP command for which the maximum data size is specified is received, the total amount of data of entries of the updated block map 411 is 102 megabytes (=26.25 gigabytes/4 kilobytes*16 bytes). Therefore, time spent for sequential writing to 102 megabytes may be shorter than the command timeout period of the UNMAP command.

Furthermore, when receiving a Read I/O for a region for which an UNMAP reservation flag indicates ON, the CM 211 responds with 0 data as reading data. Furthermore, when receiving a Write I/O for a region for which an UNMAP reservation flag indicates ON, the CM 211 sets the UNMAP reservation flag to “OFF” and performs overwrite processing. In the case where a Write I/O range and a management unit of deduplication, that is, a management unit of an UNMAP reservation flag, do not match, the CM 211 interpolates 0 data into a part of the Write data that does not match the management unit.

Processing performed by the storage control apparatus 101 according to the first embodiment is part of processing performed by the storage control apparatus 101 according to a second embodiment. Illustration of a flowchart of a process performed by the storage control apparatus 101 according to the first embodiment will be omitted. A process performed by the storage control apparatus 101 according to the first embodiment will be explained, together with a process performed by the storage control apparatus 101 according to the second embodiment, with reference to a flowchart illustrating the process performed by the storage control apparatus 101 according to the second embodiment.

### Second Embodiment

In the first embodiment, the time spent for sequential writing to entries of the block map 411 to be updated when an UNMAP command is received may be shorter than the command timeout period of the UNMAP command. The time spent for sequential writing to entries of the block map 411 represents a time depending on a load applied to the CM 211. Therefore, in the case where a high load is applied to the CM 211, command timeout may occur.

In the second embodiment, in the case where an address range specified by an UNMAP command exceeds a predetermined data size, which is 256 megabytes, the CM 211 obtains a memory region of the memory 222, and stores the address range specified by the UNMAP command into the obtained region. Then, the CM 211 updates the block map 411 asynchronously with respect to the time when the UNMAP command is received. As described above, by storing only data having the predetermined data size or more into the memory 222, exhaustion of the memory 222 may be suppressed, and a situation in which the address range specified by the UNMAP command may not be stored is suppressed. Parts similar to those explained in the first embodiment will be referred to with the same signs and explanation for those parts will be omitted.

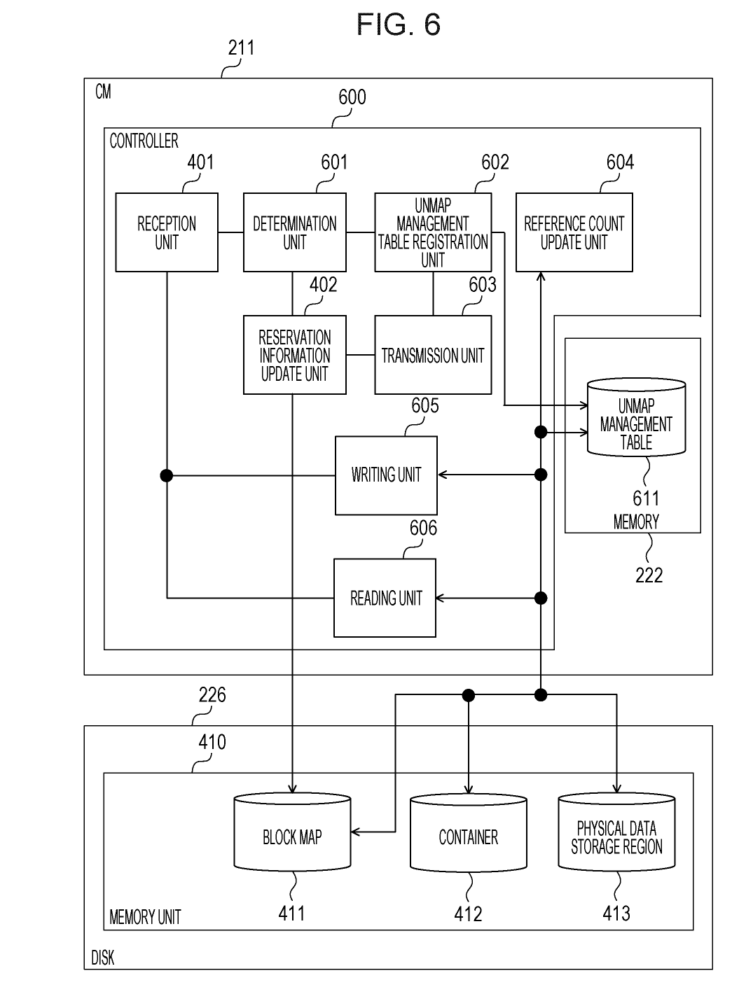

FIG. 6 is an explanatory diagram illustrating an example of a functional configuration of the CM 211 according to the second embodiment. The CM 211 according to the second embodiment includes a controller 600. The controller 600 includes a reception unit 401, a determination unit 601, a reservation information update unit 402, an UNMAP management table registration unit 602, a transmission unit 603, a reference count update unit 604, a writing unit 605, and a reading unit 606. The controller 600 implements functions of the individual units when the CPU 221 executes a program stored in a memory device. The memory device is, for example, the flash ROM 223 illustrated in FIG. 2. Processing results of the individual units are stored in the memory 222, a register of the CPU 221, a cache memory of the CPU 221, or the like.

Furthermore, the CM 211 is able to access management information which stores a parameter included in an UNMAP command. The management information will be referred to as an “UNMAP management table 611”. The UNMAP management table 611 may be present in the memory unit 410. However, it is desirable that the UNMAP management table 611 is present in a different memory unit with a higher access performance than the memory unit 410. A comparison between high and low access performances may be performed by, for example, the number of I/O accesses per unit time and the data transfer amount per unit time. In the example of FIG. 6, the UNMAP management table 611 is present in the memory 222 having a higher access performance than the disk 226.

The UNMAP management table 611 includes the range of logical addresses of a deletion target and update information indicating whether or not each UNMAP reservation flag corresponding to a deletion target division range obtained by dividing the range of the logical addresses of the deletion target data in the block map 411 has been updated to “ON”. The size of a deletion target division range is determined by an administrator of the storage system 200 or the like. For example, the data size of a deletion target division range is 256 megabytes. Furthermore, for easier management, it is desirable that the size of a deletion target division range is an integer multiple of a management nit of an UNMAP reservation flag.

Furthermore, update information may have a data capacity of one bit to indicate whether or not update is completed. A group of pieces of update information will be referred to as an “UNMAP reservation Bitmap”. Furthermore, each Bit of an UNMAP reservation Bitmap stores “setting is completed” indicating that an UNMAP reservation flag for a corresponding Bit has been updated to “ON” or “setting is not completed” indicating that updating to presence of a reservation for deletion is not completed. “Setting is completed” and “setting is not completed” may be represented by values “1” and “0”, respectively, or values “0” and “1”, respectively.

When the reception unit 401 receives an UNMAP command, the determination unit 601 determines whether or not the range of deletion target data exceeds a predetermined data size. The predetermined data size is a value determined by an administrator of the storage system 200 or the like. Division size of deletion target data is, for example, 256 megabytes. When the reception unit 401 receives an UNMAP command, in the case where the range of deletion target data does not exceed the predetermined data size, the reservation information update unit 402 and the transmission unit 603 perform the processing illustrated in FIG. 4.

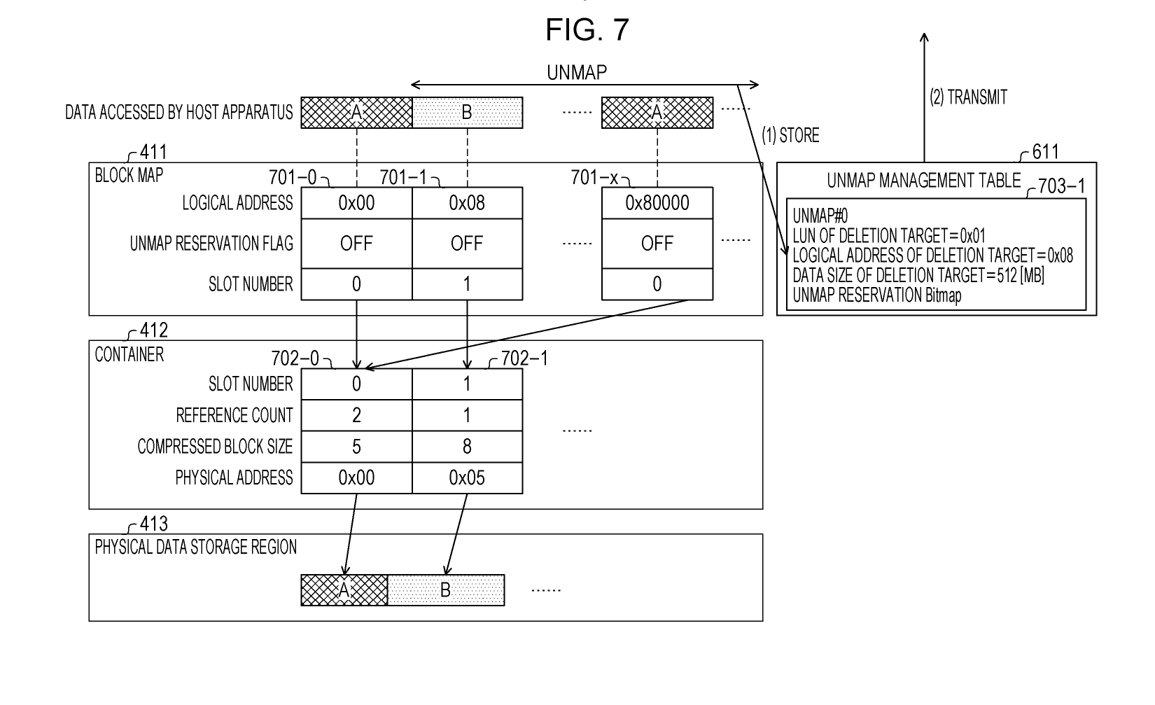

In the case where the determination unit 601 determines that the range of deletion target data exceeds the predetermined data size, the UNMAP management table registration unit 602 stores an entry of the UNMAP management table 611 into the memory 222. An entry of the UNMAP management table 611 includes the range of logical addresses of a deletion target and an UNMAP reservation Bitmap. A specific method for setting an UNMAP reservation Bitmap will be described later with reference to FIG. 7.

In addition to the function of the transmission unit 403 illustrated in FIG. 4, the transmission unit 603 transmits response information regarding an UNMAP command to the host apparatus 202 when the UNMAP management table registration unit 602 stores an entry of the UNMAP management table 611 into the memory 222.

Asynchronously with the transmission of the response information regarding the UNMAP command by the transmission unit 603, the reference count update unit 604 refers to the UNMAP management table 611 and updates an UNMAP reservation flag in the block map 411. Furthermore, the reference count update unit 604 refers to the updated block map 411 and updates the reference count of the container 412.

When the reception unit 401 receives a Write I/O command, the writing unit 605 confirms a Bit corresponding to a deletion target division range including a Write I/O range in the UNMAP reservation Bitmap in the UNMAP management table 611. In the case where the corresponding Bit indicates “setting is not completed”, the writing unit 605 updates the UNMAP reservation flag for the corresponding Bit to “ON”, and updates the corresponding Bit to “setting is completed”. In the case where an UNMAP reservation flag corresponding to the Write I/O range in the updated block map 411 indicates “ON”, the writing unit 605 updates the UNMAP reservation flag to “OFF”. Furthermore, the writing unit 605 writes, as normal deduplication processing, data obtained by removing duplication between Write data and each data included in each divided region in the physical data storage region 413 into any of the divided regions.

For example, in the case where a received Write I/O command is a request for writing to 0x08 to 0x1F, the leading Bit of an UNMAP reservation Bitmap in the UNMAP management table 611 indicates “setting is not completed”, and a deletion target division range for the corresponding Bit is a range from 0x08 to 0x80000, the writing unit 605 updates the UNMAP reservation flag for the range from 0x08 to 0x80000 to “ON” and sets the leading Bit of the UNMAP reservation Bitmap to “setting is completed”.

When the reception unit 401 receives a Read I/O command, the reading unit 606 confirms a Bit corresponding to a deletion target division range including a Read I/O range in the UNMAP reservation Bitmap in the UNMAP management table 611. In the case where the corresponding Bit indicates “setting is not completed”, the reading unit 606 sets data of the corresponding deletion target division range of the Read data included in a response to the Read I/O command to 0 data. Furthermore, in the case where the UNMAP reservation flag for the Read I/O range in the block map 411 indicates “ON”, the reading unit 606 sets data for the corresponding UNMAP reservation flag in the Read data to 0 data.

FIG. 7 is an explanatory diagram illustrating an example of an operation performed when an UNMAP command is received in the second embodiment. The block map 411 illustrated in FIG. 7 includes entries 701-0, 701-1 , . . . , 701-x, and so on. The container 412 illustrated in FIG. 7 includes entries 702-0, 702-1, and so on.

The relationship of data managed by a logical address and data managed by a physical address will be explained below with reference to FIG. 7. The entries 701-0, 701-1 , . . . , 701-x, and so on manage data of the logical addresses 0x00, 0x08 , . . . , 0x80000, and so on. The host apparatus 202 specifies the logical address 0x00 to access the data A. In a similar manner, the host apparatus 202 specifies the logical address 0x08 to access the data B, specifies the logical address 0x80000 to access the data A, and so on. As described above, the logical address 0x00 and the logical address 0x80000 are specified so that the same contents, the data A, is accessed. In FIG. 7, the data A is represented in a thick hatching pattern, and the data B is represented in a light hatching pattern.

The same data is accessed by specifying the logical address 0x00 and the logical address 0x80000. Therefore, a slot number of each of the entries 701-0 and 701-x is “0”. Furthermore, a slot number of the entry 701-1 is “1”.

The entry 702-0 having the slot number “0” manages data of the physical address 0x00. In a similar manner, the entry 702-1 having the slot number “1” manages data of the physical address 0x05. Compressed data A is stored in the physical address 0x00 in the physical data storage region 413. In a similar manner, compressed data B is stored in the physical address 0x05 in the physical data storage region 413.

In the case where the CM 211 receives an UNMAP command in which a leading address is the logical address 0x08 and an address range is 512 megabytes from the host apparatus 202, the address range exceeds 256 megabytes. Therefore, as illustrated in (1) of FIG. 7, the entry 703-1 is registered in the UNMAP management table 611. Then, the CM 211 transmits response information regarding the UNMAP command to the host apparatus 202, as illustrated in (2) of FIG. 7.

An entry of the UNMAP management table 611 includes a number for identifying an UNMAP command, a LUN of a deletion target, a logical address of a deletion target, a data size of a deletion target, and a Bitmap. The range of logical addresses of a deletion target includes logical addresses from a logical address of the deletion target to a logical address obtained by adding the data size of the deletion target to the logical address of the deletion target. Furthermore, the UNMAP reservation Bitmap represents a bitmap sequence formed by Bits obtained by dividing the range of logical addresses of a deletion target with a maximum size of 26.25 gigabytes in units of 256 megabytes. The UNMAP reservation Bitmap is represented by data of 14 bytes. One bit of the UNMAP reservation Bitmap corresponds to the update information illustrated in FIG. 6.

Furthermore, when receiving a Read I/O for a range that overlaps with the range of logical addresses of a deletion target in the UNMAP management table 611, the CM 211 responds with 0 data. Furthermore, when receiving a Write I/O for a range that overlaps with the range of the logical addresses of the deletion target in the UNMAP management table 611, the CM 211 sets an UNMAP reservation flag for the range of the logical addresses of the corresponding deletion target in the block map 411 to “ON”.

Furthermore, every time that an UNMAP command for a range of logical addresses of a deletion target of 256 megabytes or more is received, the CM 211 registers a new entry with the UNMAP management table 611. The CM 211 releases each entry of the UNMAP management table 611 after setting of all the UNMAP reservation flags of the block map 411 corresponding to the entry is completed. Therefore, the UNMAP management table 611 may include no entry or a plurality of entries.

Furthermore, at the time of registration of the UNMAP management table 611, the CM 211 sets, out of Bits in the UNMAP reservation Bitmap, a Bit obtained by dividing the range of the logical addresses of the deletion target of the UNMAP command by 256 megabytes to “setting is not completed”. For example, in the case where the range of the logical addresses of the deletion target of the UNMAP command is exactly 256 megabytes, the CM 211 sets the leading one Bit of the UNMAP reservation Bitmap to “setting is not completed”. When receiving a Write I/O command for a range that overlaps with the range of the logical addresses of the deletion target in the UNMAP management table 611, the CM 211 sets UNMAP reservation flags for 256 megabytes. The CM 211 sets Bits of the UNMAP reservation Bitmap corresponding to the range that overlaps with the range of the logical addresses of the deletion target in the UNMAP management table 611 to “setting is completed”.

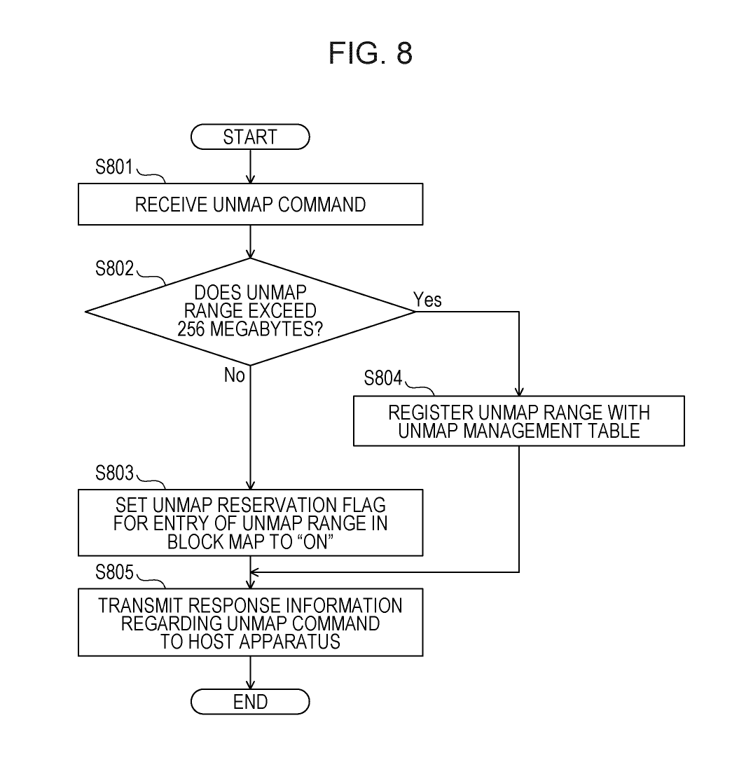

Next, flowcharts of processes performed by the CM 211 in the second embodiment will be described below with reference to FIGS. 8, 9, 11, and 12.

FIG. 8 is a flowchart illustrating an example of a processing procedure performed when an UNMAP command is received in the second embodiment. The CM 211 receives an UNMAP command (step S801). Next, the CM 211 determines whether or not an UNMAP range exceeds 256 megabytes (step S802). In the case where the UNMAP range does not exceed 256 megabytes (step S802: No), the CM 211 sets an UNMAP reservation flag for an entry of the UNMAP range in the block map 411 to “ON” (step S803). In the case where the UNMAP range exceeds 256 megabytes (step S802: Yes), the CM 211 registers the UNMAP range with the UNMAP management table 611 (step S804).

After the processing of step S803 or S804, the CM 211 transmits response information regarding the UNMAP command to the host apparatus 202 (step S805). After the processing of step S805, the CM 211 ends the UNMAP command reception time process.

Furthermore, in the UNMAP command reception time process in the first embodiment, the processing of step S802 may be skipped and the processing of step S803 may be performed.

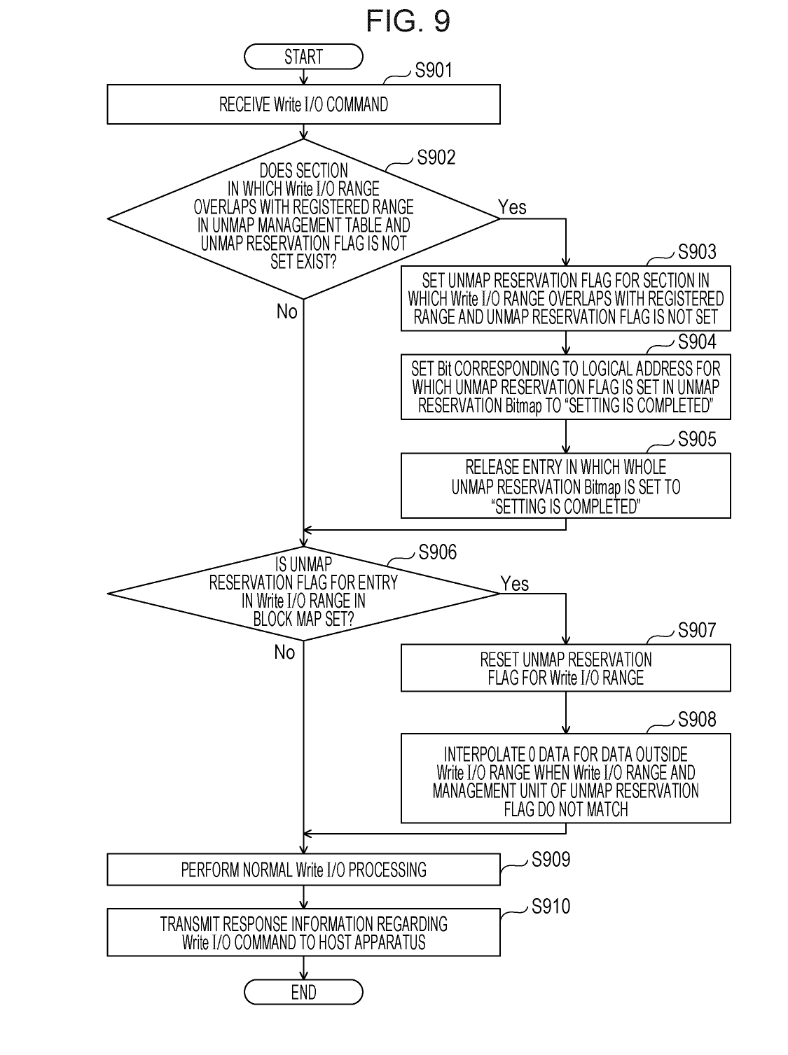

FIG. 9 is a flowchart illustrating an example of a processing procedure performed when a Write I/O command is received in the second embodiment. The CM 211 receives a Write I/O command (step S901). Next, the CM 211 determines whether or not there is a section in which a Write I/O range overlaps with a registered range in the UNMAP management table 611 and an UNMAP reservation flag is not set (step S902).

In the case where there is a section in which the Write I/O range overlaps with the registered range in the UNMAP management table 611 and an UNMAP reservation flag is not set (step S902: Yes), the CM 211 sets the UNMAP reservation flag for the corresponding section (step S903). Next, the CM 211 sets a Bit corresponding to a logical address for which the UNMAP reservation flag is set in an UNMAP reservation Bitmap to “setting is completed” (step S904). Then, in the case where the whole UNMAP reservation Bitmap in the UNMAP management table 611 is set to “setting is completed”, the CM 211 releases an entry of the UNMAP management table 611 in which the whole UNMAP reservation Bitmap is set to “setting is completed” (step S905). In the case where all the entries in the UNMAP management table 611 are released, the CM 211 releases the UNMAP management table 611 itself.

After the processing of step S905 or in the case where there is no section in which an UNMAP reservation flag is not set (step S902: No), the CM 211 determines whether or not an UNMAP reservation flag for an entry in the Write I/O range in the block map 411 is set (step S906). In the case where an UNMAP reservation flag for the entry in the Write I/O range in the block map 411 is set (step S906: Yes), the CM 211 resets the UNMAP reservation flag for the Write I/O range, that is, set to “OFF” (step S907). Then, in the case where the Write I/O range does not match a management unit of the UNMAP reservation flag, the CM 211 interpolates 0 data for data outside the Write I/O range (step S908).

After the processing of step S908 or in the case where an UNMAP reservation flag for the entry in the Write I/O range in the block map 411 is not set (step S906: No), the CM 211 performs normal Write I/O processing (step S909). The normal Write I/O processing represents Write I/processing performed in the case where there is no UNMAP. Specifically, in the case where the same data as writing data exists in the physical data storage region 413, the CM 211 increments by one the reference count of the entry that manages the corresponding data in the container 412. Furthermore, in the case where the same data as writing data does not exist in the physical data storage region 413, the CM 211 acquires a new slot number, and adds an entry having the acquired slot number in the container 412.

After the processing of step S909, the CM 211 transmits response information regarding the Write I/O command to the host apparatus 202 (step S910). After the processing of step S910, the CM 211 ends the Write I/O command reception time process.

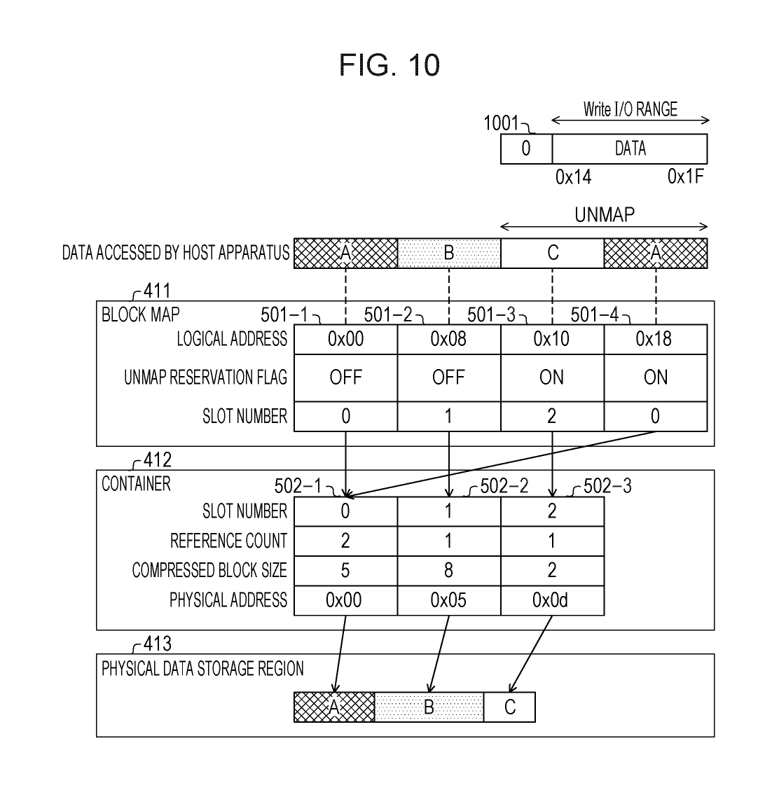

Furthermore, in the Write I/O command reception time process in the first embodiment, the determination result in step S902 may be No. Next, regarding the processing of step S908, an example of Write data for a case where a Write I/O range does not match the management unit of an UNMAP reservation flag will be described with reference to FIG. 10.

FIG. 10 is an explanatory diagram illustrating an example of writing data for a case where a Write I/O range does not match the management unit of an UNMAP reservation flag. In FIG. 10, a state in which a Write I/O occurs after the state illustrated in FIG. 5.

In FIG. 10, the Write I/O range includes the logical addresses 0x14 to 0x1F. The management unit of an UNMAP reservation flag illustrated in FIG. 10 is on an 8-byte boundary, and 0x14, which is the leading logical address in the Write I/O range, is a logical address not on the 8-byte boundary. Therefore, in the example of FIG. 10, the Write I/O range does not match the management unit of the UNMAP reservation flag.

In this case, the CM 211 interpolates 0 data for data on the management unit that overlaps with the Write I/O range but outside the Write I/O range. In the example of FIG. 10, the management unit that overlaps with the Write I/O range is from 0x10 to 0x17, and a range outside the Write I/O range includes 0x10 to 0x13. Therefore, data of the logical addresses 0x10 to 0x13 is interpolated by 0 data 1001.

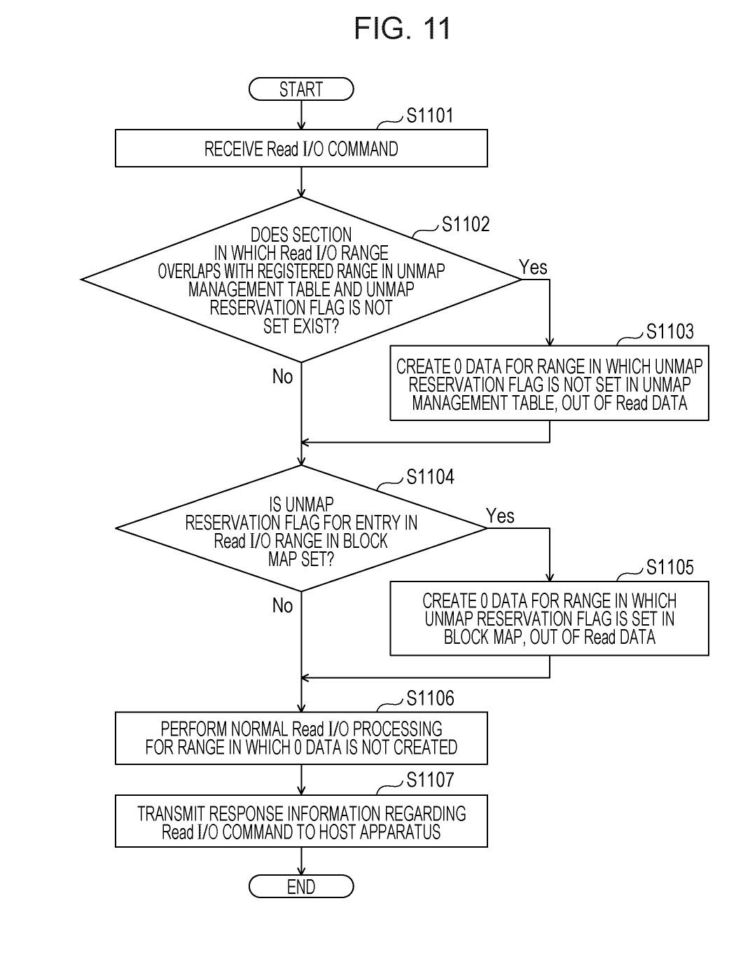

FIG. 11 is a flowchart illustrating an example of a processing procedure performed when a Read I/O command is received in the second embodiment. The CM 211 receives a Read I/O command (step S1101). Next, the CM 211 determines whether or not there is a section in which a Read I/O range overlaps with a registered range in the UNMAP management table and an UNMAP reservation flag is not set (step S1102). In the case where there is a section in which an UNMAP reservation flag is not set (step S1102: Yes), the CM 211 creates 0 data for the range in which an UNMAP reservation flag is not set in the UNMAP management table 611, out of Read data included in a response (step S1103).

After the processing of step S1103 or in the case where there is no section in which an UNMAP reservation flag is not set (step S1102: No), the CM 211 determines whether or not an UNMAP reservation flag for an entry in the Read I/O range in the block map 411 is set (step S1104). In the case where an UNMAP reservation flag for the entry in the Read I/O range in the block map 411 is set (step S1104: Yes), the CM 211 creates 0 data for the range in which the UNMAP reservation flag is set in the block map, out of the Read data included in the response (step S1105).

After the processing of step S1105 or in the case where an UNMAP reservation flag for the entry in the Read I/O range in the block map 411 is not set (step S1104: No), the CM 211 performs normal Read I/O processing for a range where 0 data is not created, out of the Read data included in the response (step S1106). The normal Read I/O processing represents Read I/O processing performed in the case where there is no UNMAP. Then, the CM 211 transmits response information regarding the Read I/O command to the host apparatus 202 (step S1107). After the processing of step S1107, the CM 211 ends the Read I/O command reception time process.

Furthermore, in the Read I/O command reception time process in the first embodiment, the determination result in step S1102 may be No.

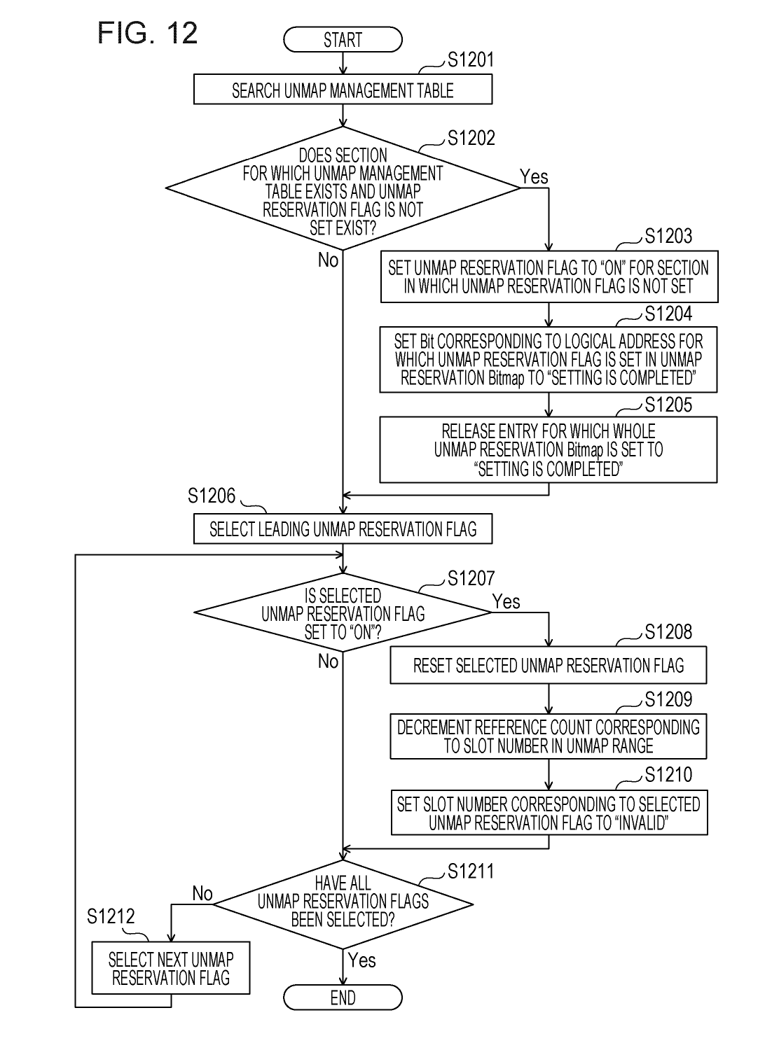

FIG. 12 is a flowchart illustrating an example of an asynchronous processing procedure in the second embodiment. The CM 211 searches the UNMAP management table 611 (step S1201). The CM 211 determines whether or not there is a section for which the UNMAP management table 611 exists and an UNMAP reservation flag is not set (step S1202).

In the case where there is a section in which an UNMAP reservation flag is not set (step S1202: Yes), the CM 211 sets the UNMAP reservation flag to “ON” for the section in which the UNMAP reservation flag is not set (step S1203). Next, the CM 211 sets a Bit corresponding to a logical address for which the UNMAP reservation flag is set in an UNMAP reservation Bitmap to “setting is completed” (step S1204). In the case where the whole UNMAP reservation Bitmap in the UNMAP management table 611 is set to “setting is completed”, the CM 211 releases an entry for which the whole UNMAP reservation Bitmap is set to “setting is completed” (step S1205). In the case where all the entries in the UNMAP management table 611 are released, the CM 211 releases the UNMAP management table 611 itself.

After the processing of step S1205 or in the case where there is no section in which an UNMAP reservation flag is not set (step S1202: No), the CM 211 selects the leading UNMAP reservation flag (step S1206). Next, the CM 211 determines whether or not the selected UNMAP reservation flag is set to “ON” (step S1207). In the case where the selected UNMAP reservation flag is set to “ON” (step S1207: Yes), the CM 211 resets the selected UNMAP reservation flag, that is, sets the selected UNMAP reservation flag to “OFF” (step S1208). Next, the CM 211 decrements the reference count corresponding to a slot number for the UNMAP range (step S1209). Then, the CM 211 sets the slot number corresponding to the selected UNMAP reservation flag to “INVALID” (step S1210).

After the processing of step S1210 or in the case where the selected UNMAP reservation flag is not set to “ON” (step S1207: No), the CM 211 determines whether or not all the UNMAP reservation flags have been selected (step S1211). In the case where there is an UNMAP reservation flag that has not been selected (step S1211: No), the CM 211 selects the next UNMAP reservation flag (step S1212), and proceeds to the processing of step S1207.

In the case all the UNMAP reservation flags have been selected (step S1211: Yes), the CM 211 ends the asynchronous process. Furthermore, in the asynchronous process in the first embodiment, the determination result in step S1202 may be No.

As described above, in the first embodiment, when an UNMAP reservation flag is provided in the block map 411 and an UNMAP reservation flag corresponding to a logical address included in an UNMAP command is set to ON, the CM 211 responds to the UNMAP command. Accordingly, the CM 211 is able to respond to the UNMAP command prior to updating of a reference count. Therefore, the time spent to respond to the UNMAP command may be shortened.

Furthermore, in the first embodiment, regarding a Write I/O command, when an UNMAP reservation flag corresponding to a Write I/O range in the block map 411 indicates “ON”, the CM 211 updates the UNMAP reservation flag to “OFF”. Accordingly, the CM 211 may ensure normal processing on the Write I/O command while the time spent to respond to the UNMAP command being shortened.

Furthermore, in the first embodiment, regarding a Read I/O command, when an UNMAP reservation flag corresponding to a Write I/O range in the block map 411 indicates “ON”, the CM 211 sets Read data included in a response to 0 data. Accordingly, the CM 211 may ensure normal processing on the Read I/O command while the time spent to respond to the UNMAP command being shortened. Furthermore, in the operation described above, an UNMAP reservation flag may not be updated for processing on the Read I/O command.

Furthermore, in the second embodiment, in the case where an UNMAP range exceeds 256 megabytes, the CM 211 may register an entry in the UNMAP management table 611 and respond to an UNMAP command. Accordingly, even in the case where it takes a long time to update an UNMAP reservation flag in the block map 411, the CM 211 may shorten the time spent to respond to the UNMAP command, and occurrence of timeout may be reduced.

Furthermore, in the second embodiment, when a Write I/O command is issued for a range corresponding to a Bit of an UNMAP reservation Bitmap in which “setting is not completed” is set, the CM 211 sets an UNMAP reservation flag for the corresponding Bit to “ON”. Accordingly, also in the second embodiment, the CM 211 may ensure normal processing on the Write I/O command. Furthermore, in the operation described above, the UNMAP reservation flag for only the corresponding Bit is set to “ON” but UNMAP reservation flags for all the Bits in the UNMAP reservation Bitmap are not set to “ON”. Therefore, by appropriately setting the size of each deletion target division range corresponding to a Bit, the CM 211 may process the Write I/O command in the second embodiment without exceeding the timeout of the Write I/O command.

Furthermore, in the second embodiment, when a Read I/O command is issued for a range corresponding to a Bit of an UNMAP reservation Bitmap in which “setting is not completed” is set, the CM 211 sets data of Read data in a range of the corresponding Bit to 0 data. Accordingly, also in the second embodiment, the CM 211 may ensure normal processing on the Read I/O command. Furthermore, in the operation described above, an UNMAP reservation flag may not be updated for processing on the Read I/O command.

Furthermore, in the second embodiment, the CM 211 may store the UNMAP management table 611 in the memory 222. Accordingly, compared to a case where the UNMAP management table 611 is stored in the disk 226, the CM 211 may transmit a response regarding an UNMAP command quickly.

Furthermore, a storage control method described in an embodiment may be implemented when a program prepared in advance is executed by a computer such as a personal computer or a workstation. The storage control program is recorded in a computer-readable recording medium such as a hard disk, a flexible disk, a compact disc-read only memory (CD-ROM), or a digital versatile disk (DVD), and is executed when the storage control program is read from the recording medium by a computer. The storage control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control apparatus that controls a storage including divided regions obtained by dividing a storage region, the divided regions including non-duplicate data that do not overlap with one another, the storage control apparatus comprising:
a memory; and
a processor coupled to the memory and configured to execute a process including;
storing logical address information that includes, for each of a plurality of logical addresses, identification information for identifying one of the divided regions allocated to the logical addresses and reservation information indicating whether or not there is a reservation for deletion of data in the divided region,
storing physical address information that includes, for each of the divided regions, reference information regarding a logical address for reference to the divided region and a physical address of the divided region,
updating, in response to reception of a deletion request including a range of logical addresses of deletion target data, the reservation information corresponding to the range of the logical addresses of the deletion target data in the logical address information to presence of a reservation for deletion,
performing, in response to the update of the reservation information, deletion processing for transmitting response information regarding the deletion request to a request source of the deletion request, and
performing, separately from the deletion processing, update processing for referring to the logical address information and updating the reference information regarding the logical address.

2. The storage control apparatus according to claim 1,
wherein the process further including;
referring to, in response to reception of a write request including write target data and a range of logical addresses of the write target data, the reservation information corresponding to the range of the logical addresses of the write target data in the logical address information, and updating, in a case where the reservation information indicates presence of a reservation for deletion, the reservation information to absence of the reservation for deletion.

3. The storage control apparatus according to claim 1,
wherein the process further including;
referring to, in response to reception of a read request including a range of logical addresses of read target data, the reservation information corresponding to the range of the logical addresses of the read target data in the logical address information, and setting, in a case where the reservation information indicates presence of a reservation for deletion, a predetermined value, as read out data to be included in a response to the read request, indicating that no divided region is allocated to the logical address.

4. The storage control apparatus according to claim 1,
wherein the process further including;
storing, in response to reception of the deletion request, in a case where the range of the logical addresses of the deletion target data exceeds a predetermined data size, management information including the range of the logical addresses of the deletion target data and update information indicating whether or not each piece of reservation information corresponding to each of deletion target division ranges obtained by dividing the range of the logical addresses of the deletion target data in the logical address information has been updated to presence of a reservation for deletion,
performing, in response to the storing of the management information, the deletion processing,
referring to, separately from the deletion processing, the management information and updating the reservation information in the logical address information, and
referring to the updated logical address information and performing the update processing.

5. The storage control apparatus according to claim 4,
wherein the process further including;
referring to, in response to reception of a write request including write target data and a range of logical addresses of the write target data, the management information, updating, in a case where update information corresponding to a deletion target division range including the range of the logical addresses of the write target data indicates that the reservation information corresponding to the deletion target division range has not been updated to presence of a reservation for deletion, the reservation information to presence of a reservation for deletion, and updating the update information to indicate that updating to presence of a reservation for deletion has been performed, and
updating, in a case where the updated reservation information corresponding to the range of the logical addresses of the write target data in the logical address information indicates presence of a reservation for deletion, the reservation information to absence of a reservation for deletion.

6. The storage control apparatus according to claim 4,
wherein the process further including;
referring to, in response to reception of a read request including a range of logical addresses of read target data, the management information, and setting, in a case where update information corresponding to a deletion target division range including the range of the logical addresses of the read target data indicates that the reservation information corresponding to the deletion target division range has not been updated to presence of a reservation for deletion, a predetermined value, as reading data included in a response to the read request, indicating that no divided region is allocated to the logical address, and
setting, in a case where the reservation information corresponding to the range of the logical addresses of the read target data in the logical address information indicates presence of a reservation for deletion, data of the reading data that corresponds to the reservation information to the predetermined value.

7. The storage control apparatus according to claim 4,
wherein a device that stores the management information has a higher access performance than a device that stores the logical address information and the physical address information.

8. A non-transitory computer readable storage medium storing a storage control program causing a computer, having a storage including divided regions obtained by dividing a storage region, the divided regions including non-duplicate data that do not overlap with one another, to perform a process comprising;
storing logical address information that includes, for each of a plurality of logical addresses, identification information for identifying one of the divided regions allocated to the logical addresses and reservation information indicating whether or not there is a reservation for deletion of data in the divided region,
storing physical address information that includes, for each of the divided regions, reference information regarding a logical address for reference to the divided region and a physical address of the divided region,
updating, in response to reception of a deletion request including a range of logical addresses of deletion target data, the reservation information corresponding to the range of the logical addresses of the deletion target data in the logical address information to presence of a reservation for deletion,
performing, in response to the update of the reservation information, deletion processing for transmitting response information regarding the deletion request to a request source of the deletion request, and
performing, separately from the deletion processing, update processing for referring to the logical address information and updating the reference information regarding the logical address.

9. The storage medium according to claim 8, wherein the computer is coupled to a memory, and the process further comprising;
storing in the memory, in response to reception of the deletion request, in a case where the range of the logical addresses of the deletion target data exceeds a predetermined data size, management information including the range of the logical addresses of the deletion target data and update information indicating whether or not each piece of reservation information corresponding to each of deletion target division ranges obtained by dividing the range of the logical addresses of the deletion target data in the logical address information has been updated to presence of a reservation for deletion,
performing, in response to the storing of the management information, the deletion processing,
referring to, separately from the deletion processing, the management information and updating the reservation information in the logical address information, and
referring to the updated logical address information and performing the update processing.
